(19) United States
(12) Patent Application Publication
(10) Pub. No.: US 2023/0206155 A1
(43) Pub. Date: Jun. 29, 2023

(54) DATA DRIVEN CUSTOMER CHURN ANALYTICS

(71) Applicant: Palo Alto Networks, Inc., Santa Clara, CA (US)

(72) Inventors: Guangyu Zhu, San Jose, CA (US); Julian Levart Aronowitz, Culver City, CA (US); Tomena Lionel Some, Santa Clara, CA (US); Venugopal Malyala, Fremont, CA (US)

(21) Appl. No.: 17/646,073

(22) Filed: Dec. 27, 2021

(51) Int. Cl. G06Q 10/06; G06Q 30/02; G06N 5/04

(52) U.S. Cl. CPC G06Q 10/06375; G06Q 30/0202; G06N 5/04

(57) ABSTRACT

A customer analytics ecosystem has been created that identifies factors in customer/account data that have correlations with customer churn based on statistical analysis, uses those factors to then predict likelihood of customer churn for customers, and generates recommendations to retain those customers identified as likely to attrite. Statistical analysis performed on customer data to yield correlation coefficients that provide insight into which variables/factors in customer data have correlations with customer churn. The identified churn factors are used as features to train a churn prediction model. The churn prediction model is trained to predict churn outcome for a customer based on at least some of the churn factors. Causal inference models are run for customer retention solutions (“treatments”) to obtain an estimated effect of each treatment on the churn outcome. The set of treatments can be ranked and presented as recommendations to retain the identified customer.

### BACKGROUND

The disclosure generally relates to computing (e.g., CPC G06) and customer churn analysis (e.g., CPC Subclass G06Q).

“Customer churn” refers to attrition or defection of customers from a business. Customer churn can inform strategies for customer retention and is a factor in calculating a customer's lifetime value. To manage customer churn, data analytics is employed to predict customer churn.

### BRIEF DESCRIPTION OF THE DRAWINGS

Embodiments of the disclosure may be better understood by referencing the accompanying drawings.

FIG. 1 depicts a conceptual diagram of a customer retention ecosystem with recurring feature data refresh and churn factor feature selection re-evaluation.

FIG. 2 is a flowchart of example operations for predicting churn likelihood of customers with features identified as having strong correlations with attrition or churn.

FIG. 3 is a flowchart of example operations for determining recommended customer retention solutions with estimated customer churn treatment effectiveness.

FIG. 4 depicts an example computer system with an analytics based customer retention ecosystem.

### DESCRIPTION

The description that follows includes example systems, methods, techniques, and program flows that embody aspects of the disclosure. However, it is understood that this disclosure may be practiced without these specific details. For instance, this disclosure refers to example machine learning algorithms in illustrative examples. Aspects of this disclosure can instead use other machine learning algorithms, for instance an artificial neural network instead of gradient boosted trees for churn prediction. In other instances, well-known instruction instances, protocols, structures and techniques have not been shown in detail in order not to obfuscate the description.

Overview

A customer analytics ecosystem has been created that identifies factors in customer/account data that have correlations with customer churn based on statistical analysis, uses those factors to then predict likelihood of customer churn for customers, and generates recommendations to retain those customers identified as likely to attrite. Statistical analysis performed on customer data to yield correlation coefficients that provide insight into which variables/factors in customer data have correlations with customer churn (“churn factors”). At least some of the identified churn factors are used as features to train a churn prediction model. The churn prediction model is trained to predict churn outcome for a customer based on at least some of the churn factors. For a customer identified with the churn prediction model as likely to not be retained, causal inference models are run for customer retention solutions (“treatments”) to obtain an estimated effect of each treatment on the churn outcome (“treatment effect estimate”). The set of treatments can be ranked and presented as recommendations to retain the identified customer.

### Terminology

The term “pipeline” is used herein to refer to multiple software components logically arranged in series for output of a software module to be input for a next software component. For example, a result of a database query from a database is provided as input to a statistical model, perhaps with some processing beforehand (e.g., normalization). The pipeline likely includes program code to logically connect the software components to allow flow of inputs and outputs without manual intervention.

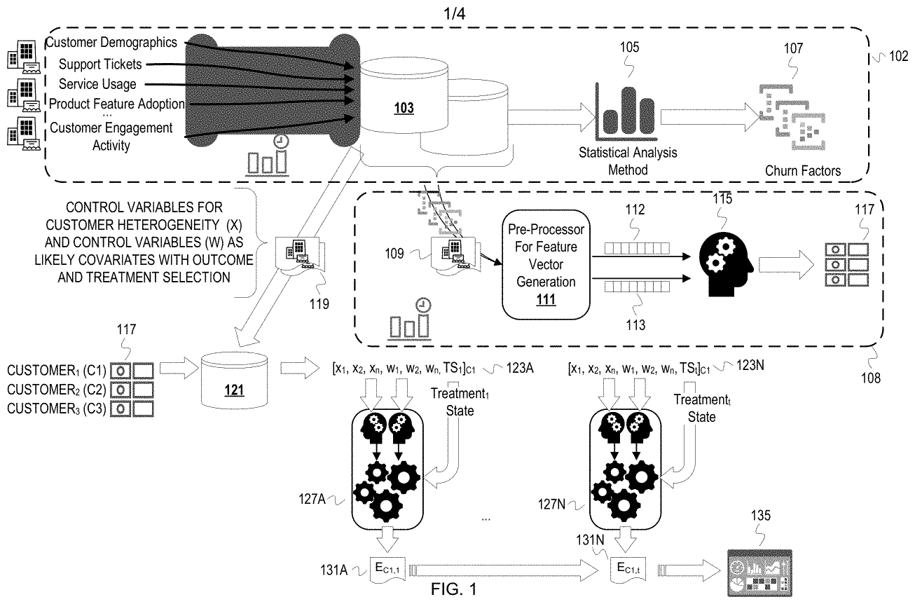

Example Illustrations FIG. 1 depicts a conceptual diagram of a customer retention ecosystem with recurring feature data refresh and churn factor feature selection re-evaluation. The ecosystem includes different pipelines 102, 108, each of which includes a time symbol that represents recurring execution or processing of the pipeline. The pipeline 102 is a churn factor discovery pipeline and the pipeline 108 is a customer churn prediction pipeline. The pipeline 102 discovers or identifies churn factors which can then be used in the pipeline 108 to obtain predictions for churn likelihood for customers. For customers identified from the pipeline 108, a set of causal inference models 127A-127N corresponding to different customer churn treatments or retention strategies are run to obtain estimated effectiveness of the different treatments which can be used to form customer retention recommendations. The pipelines 102, 108, and causal inference models 127A-127N can be run asynchronously or with different degrees of connection/dependence. As an example, a process can select the n customers with highest likelihood of churn as indicated by the pipeline 108 and run the causal inference models 127A-127N for each of the n customers.

The pipeline 102 uses statistical analysis of historical customer data to identify churn factors. The pipeline 102 may be run on demand, at recurring time intervals (e.g., every month), and/or according to a different trigger (e.g., increased variation in customer attributes, a new customer variable, etc.). FIG. 1 depicts examples of the types of customer variables that may be analyzed including customer demographics (e.g., sales type, license type, onboarding duration, onboarding status, etc.), support tickets (e.g., engineer response time, case age, trend in amount of support tickets in a specified time period, etc.), service usage (e.g., number of logins, workload usage, container usage, cloud usage, etc.), product feature adoption (e.g., frequency and duration of feature adoption, alert details, compliance dashboard, etc.), customer engagement activity (e.g., time since last engaged, call frequency, email frequency, meeting frequency, etc.), etc. The customer data is stored into a set of data repositories 103. The data repositories 103 can be a database, a store, a data lake, or a combination thereof. Data for each of the customer variables of each customer represented in the repositories 103 is paired with churn outcome for the customer to be analyzed with a statistical analysis method 105.

The statistical analysis method 105 is used to determine whether a monotonic relationship exists between each of the customer variables and churn outcome. The statistical analysis method 105 is chosen based partly on a capacity to determine monotonic relationships regardless of the relationship being linear or non-linear. For example, the Spearman's rank order can be used for the statistical analysis method 105. Continuing with the Spearman's rank order correlation, customer data for each chosen customer variable is paired with a corresponding churn outcome and after ranking the Spearman's rank order correlation analysis is run on the ranked and paired dataset to obtain a correlation coefficient for that customer variable. The correlation coefficient is between −1 and 1 which indicates strength and direction of the monotonic relationship between the customer variable and churn outcome. For churn analytics, the correlation coefficient is considered a marginal conditional probability and can be interpreted as the average impact on churn likelihood given the change of an indicator. After an initial global analysis of the customer variables, subsets of variables can be re-evaluated with the statistical analysis method 105 in response to satisfying a re-evaluation criterion (e.g., expiration of a time period, threshold amount of additional data for a customer variable, business focus on a particular customer variable, etc.). With the correlation coefficients obtained from the statistical analysis method 105, n of the customer variables with the strongest relationships with outcome churn can be identified as churn factors 107 for use in churn prediction.

The pipeline 108 uses the churn factors 107 to train a model and obtain a churn prediction model 115. Embodiments can choose from among a variety of learning algorithms to train as a predictor (e.g., artificial neural network, decision trees, support vector machines, etc.). As an example, the pipeline 108 can choose a weak learner (e.g., decision tree) and apply gradient boosting to form an ensemble of weak learners (e.g., gradient boosting decision trees) for the churn prediction model. Although churn factors will likely be stable, a change in churn factors that leads to training a new churn prediction model likely incurs hyperparameter tuning. After training to obtain the churn prediction model 115, the churn prediction model 115 can be deployed or activated in the pipeline 108. In some cases, a new model may be undergoing training while a deployed churn prediction model continues being used. With the trained, churn prediction model 115, the pipeline 108 retrieves data 109 of the churn factors for a set of customers. A pre-processor 111 pre-processes this data 109 for feature vector generation. It is not necessary for an embodiment to pre-process all or any of the data 109 for feature vector generation. However, a churn factor may be of data type (e.g., string) to encode into a numerical value, for example, depending upon the model employed. The pre-processor 111 pre-processes data of at least one of the churn factors 107 in this illustration and forms a feature vector 112 for a first customer from the subset of data 109 corresponding to the first customer and forms a feature vector 113 for a second customer from the subset of data 109 corresponding to the second customer. The pipeline 108 feeds or inputs each of the feature vectors 112, 113 into the churn prediction model 115. The pipeline 108 then assembles the churn likelihood predictions output by the churn prediction model 115 into a data structure 117 (“churn listing”) that associates an identifier of each customer with the corresponding one of the predictions.

With the listing 117, retention recommendations can be generated for selected ones of the customers identified in the listing 117. Assuming the listing 117 identifies customers {C1, C2, C3}, customer data/values corresponding to control variable sets W and X are retrieved from a repository 121. The repository 121 can be updated with data from the repositories 103 or another data source(s). The control variables W and X are features to be input into the causal inference models 127A-127N. The control variables X for a customer are observable customer variables or attributes selected to describe a customer sufficiently to increase heterogeneity of the customers represented in a dataset. The control variables W for a customer are observable customer variables/attributes selected as likely covariates with churn outcome and treatment selection. Examples of elements of W include sales type, account theatre, billing duration, and onboarding duration for a specified product. Examples of elements of X include workloads purchased, product segment, customer success program, license type, cloud service provider, days until contract end date, and days since contract start date. The non-numerical control variables can be encoded as numerical variables, for example with one hot encoding. For this illustration, W={w₁, w₂, wₙ} and X={x₁, x₂, xₙ}. For each of the causal inference models 127A-127N, a feature vector is formed for each customer with W, X, and a current or recent state (TS) of a treatment t for the customer from a set of treatments T. Treatment state is indicated in the data 119. Examples of the treatments in T include workload usage, number of logins per defined time period, manual call cadence, lifecycle phase, ratio of resolved alerts, amount of distinct integrations, engineer response time, average case age, deployed containers, and cloud service provider. For customer C1, feature vectors 123A-123N are respectively generated for the causal inference models 127A-127N.

For customer C1, the causal inference models 127A-127N respectively generate estimates of treatment effects 131A-131N. This is repeated for each of the selected customers. As an example, each of the causal inference models 127A-127N is a casual forest double machine learning estimator (CF-DMLE) that outputs an estimate of marginal conditional average treatment effect (CATE). A CF-DMLE accepts as input a feature vector that is fed into two learners. The learners can be the same or different if the learners are configured to accept the same input feature vector. Examples of the learners include a logistic regression classifier with a cross-validation estimator (Logistic Regression CV), a weighted lasso linear model with a CV estimator, and a weighted multi-task lasso linear model. The output of the two learners and a current state of a specific treatment then flow as input into a casual forest. The marginal CATE output by the causal forest is used as a measurement to assess impact/effectiveness for decreasing the likelihood of churn for a customer represented by the control variable features that form part of the input feature vector. Embodiments can configure the causal forest to accept a vector of treatment states as part of the input into the causal forest. A polynomial featurizer can be applied to treatment state TSₜ to obtain a vector of treatment states {TSₜ, TSₜ², TSₜ³} that allows the causal inference model to account for the diminishing marginal effect on churn likelihood with increasing amounts of the treatment. Embodiments are not limited to a third degree polynomial and can be chosen based on a balance of increasing dimensionality of the feature space and accounting for the diminishing returns. While the example refers to a causal forest, embodiments can instead use an orthogonal random forest estimator or a forest doubly robust estimator.

After running the causal inference models 127A-127N, the output estimates 131A-131N are aggregated for presentation with a user interface 135. Each of the effectiveness estimates 131A-131N is presented with the corresponding treatment identifier, current treatment state, and treatment increment. The information can be sorted by the estimates 131A-131N before presentation via the user interface 135.

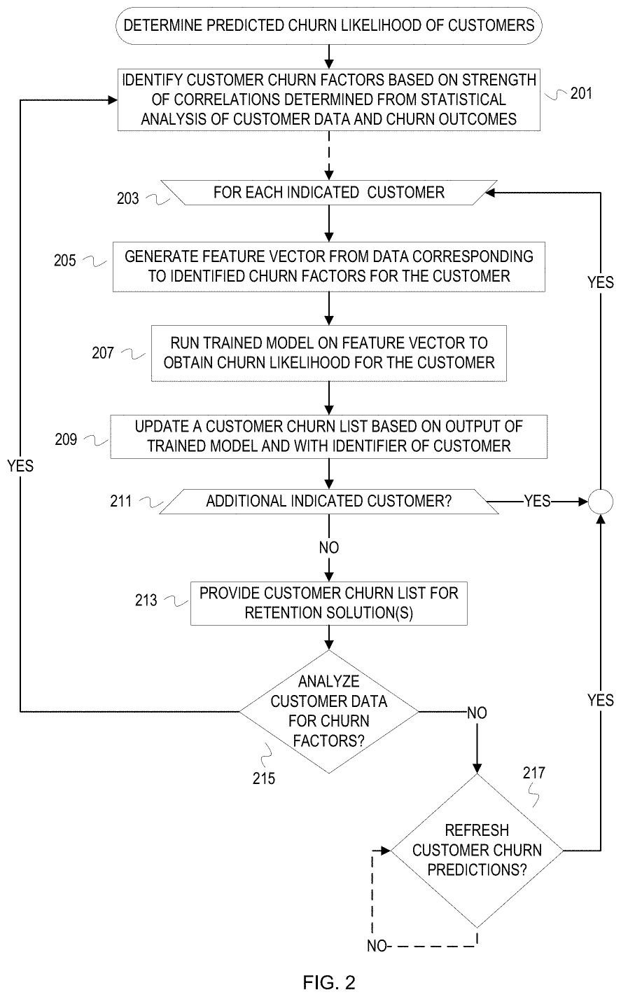

FIG. 2 is a flowchart of example operations for predicting churn likelihood of customers with features identified as having strong correlations with attrition or churn. FIG. 2 associates churn factor identification with customer churn prediction despite the two operating at substantially different time granularities and asynchronously. The asynchronous relationship between churn factor identification or re-evaluation and customer churn prediction is represented by the dashed line between blocks 201, 203. Furthermore, the statistical analysis indicated in block 201 can involve manual analysis while the other example operations can run to update churn likelihood predictions for customers periodically (e.g., daily). The description of FIG. 2 refers to a customer churn prediction system as performing the example operations. The moniker is used for ease of explanation and should not be used to limit the claims since program code organization and naming varies due to multiple factors: platform, programming language, developer preference, etc.

At block 201, the customer churn prediction system identifies customer churn factors based on strength of correlations determined from statistical analysis of customer data and churn outcomes. As described earlier, a statistical analysis method is chosen that yields correlations regardless of linearity of the relationships between each candidate impact factor and the corresponding churn outcome. Customer data is retrieved across customers and each of the variables across customers that is a candidate impact factor along with the churn outcome for the corresponding customer is input into a program implementing the statistical analysis method. The correlation coefficients obtained from the statistical analysis are used to rank the variables to allow for m of the variables to be chosen as impact factors. The customer variables available can be evaluated based on domain knowledge and/or business assessment to reduce those considered as candidate impact factors. The customer data may be filtered to exclude data for customers who were customers for less than a floor period of time (e.g., 2 months).

At block 203, churn prediction is run for each of a set of indicated customers based on the identified impact factors. Selection of customers can vary by case and/or implementation. As an example, all customers represented in available customer data for at least a threshold time period (e.g., most recent 3 months) may be selected to establish initial churn likelihoods across a customer base. Subsequently, subsets of those customers can be chosen to update the predictions and the customers resorted by likelihood. Some customers can be weighted or pinned (i.e., frozen at a position) based on another criterion (e.g., revenue from that customer). Example operations represented by blocks 205, 207, 209 are repeated for each customer.

At block 205, the customer churn prediction system generates a feature vector from data corresponding to the identified churn factors for the customer. One or more repositories are queried for customer data of the customer for each of the identified churn factors. The feature vector is formed or generated with the resulting data. In some cases, a churn factor data may be transformed according to input constraints of the churn prediction model. Some or all of the churn factor data may be a most current value within a defined time interval for a current refresh interval, while some of the churn factor data may be aggregated across the refresh interval (e.g., average case age across multiple cases) and/or aggregated at a time interval of a greater granularity than the refresh interval (e.g., dismissed alerts ratio for most recent 12 months).

At block 207, the customer churn prediction system runs the trained churn prediction model on the generated feature vector. Implementations can instantiate a different computing instance, whether physical or virtual, to run the churn prediction model on the feature vectors in parallel. The output of the churn prediction model (i.e., the churn likelihood prediction) is stored in association with an identifier of the customer.

At block 209, the customer churn prediction system updates a customer churn list based on the output of the trained churn prediction model along with the customer identifier. Assuming the churn prediction model is run for each customer in series, the customer churn list can be updated after each run or after a batch of runs. The customer churn list can be implemented with any of a variety of data structures and storage technologies. A file can be maintained as the customer churn list or a database of churn likelihoods can be maintained. For example, connector program code can detect output from a churn prediction model run and submit an update request to a database for the customer record with the predicted churn likelihood.

At block 211, the customer churn prediction system determines whether there is another indicated customer. If so, operational flow returns to block 203. Otherwise, operational flow continues to block 213.

At block 213, the customer churn prediction system provides the customer churn list for retention solution(s). Providing the customer churn list can take any of multiple realizations. Providing the customer churn list may be updating a user interface that displays a listing of churn likelihoods or indicators of churn likelihoods (e.g., color coding or graphic indicators representing severity ranges) connected to a database backend that hosts the list. Providing the customer churn list can be sending a file that embodies the customer churn list. The customer churn prediction system may select the customers with the top r predicted churn likelihoods and update a user interface and/or send a notification with the indications of the predicted churn likelihoods for those customers. The customer churn prediction system may maintain a history of predictions for customers and present changes in predictions. The extent of a change in predicted churn likelihood can bias focus for retention solution.

At block 215, the customer churn prediction system determines whether to analyze or re-assess customer data for the churn factors. With an increasing dataset and/or increased heterogeneity of customers, the strength of correlations of customer variables, at least with respect to each other, may change. Determination of whether to reassess churn factors can be triggered by various triggers, examples of which include expiration of a time interval (e.g., 6 months), increased rate of monthly customer churn, customer base growth exceeding a threshold, etc. Embodiments do not necessarily reassess all customer variables as candidate churn factors. Embodiments can select the weakest churn factors and candidate churn factors that were previously weaker but within a range of strength and limit reassessment to those customer variables. If the customer churn prediction system determines that churn factors will be reassessed, then operational flow returns to block 201. If the customer churn prediction system determines that churn factors will not be reassessed, then operational flow proceeds to block 217.

At block 217, the customer churn prediction system determines whether to refresh customer churn predictions. Due to the dynamic nature of the features that influence churn prediction (e.g., integrations, response times, alerts, etc.), the churn prediction model is run periodically to capture the changing data of the churn factors in the churn likelihood predictions. The data/value for a churn factor may change (e.g., status change) or be updated (e.g., ratio based churn factor).

After obtaining churn likelihood predictions, selection of customers for retention solution recommendations may be implemented differently. While some embodiments may automatically communicate the top c customers for obtaining retention solution recommendations based on the churn treatment effectiveness estimates, some embodiments may independently obtain the retention solution recommendations using the churn likelihood predictions as guidance or suggestions.

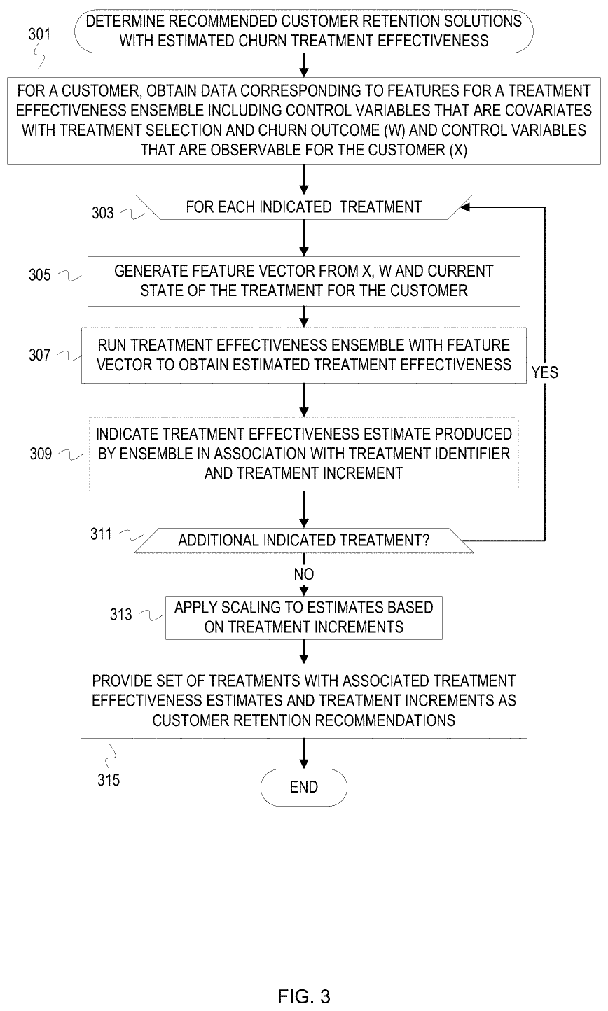

FIG. 3 is a flowchart of example operations for determining recommended customer retention solutions with estimated customer churn treatment effectiveness. As noted above, a treatment effectiveness ensemble for each of a set of treatments is run for an individual customer. If c customers are selected based on the churn likelihood predictions, then the set of treatment effectiveness ensembles for the set of treatments will be run for each of the c customers. Assuming t treatments, there would be t treatment effectiveness ensembles, each trained for a particular treatment. It is not required that all the treatment effectiveness ensembles be run. For scenario, a vendor may choose to only consider a subset of the treatments. The description of FIG. 3 refers to a retention recommendation system as performing the example operations. The moniker is used for ease of explanation and should not be used to limit the claims since program code organization and naming varies due to multiple factors: platform, programming language, developer preference, etc.

At block 301, a retention recommendation system obtains data for a customer, the customer data corresponding to features for a treatment effectiveness estimator ensemble. These features include a set of variables W that are covariates with treatment selection and churn outcome and a set of variables X that are observable customer attributes that correspond to customer heterogeneity. These features W, X are considered control variables since the features themselves are not of interest for treatment effectiveness but may influence treatment effectiveness.

At block 303, the retention recommendation system generates a feature vector and then runs each of the set of t ensembles on the feature vector. As with the churn prediction, embodiments can run the ensembles in parallel depending on compute resources.

At block 305, the retention recommendation system generates a feature vector from X, W, and a current state of the treatment TSₜ of the current iteration. As part of forming or generating the feature vector, the retention recommendation system can apply a polynomial featurizer to TSₜ unless the polynomial featurizer is embedded within the ensemble.

At block 307, the retention recommendation system runs the treatment effectiveness estimator ensemble on the feature vector to obtain an estimated treatment effectiveness.

At block 309, the retention recommendation system indicates the treatment effectiveness estimate produced by the ensemble in association with a treatment identifier and a treatment adjustment/rate. As an example, increasing integration count may be at a rate of a single integration.

At block 311, the retention recommendation system determines whether there is another treatment effectiveness estimator ensemble to run on the feature vector. If so, operational flow returns to block 303. If not, then operational flow continues to block 313.

At block 313, the retention recommendation system applies scaling to the estimates based on the treatment rates. To illustrate, the set of treatments may include call cadence per week and open alert ratio per month. The retention recommendation system would scale the increment and effectiveness estimate of one or both to be at the same time granularity.

At block 315, the retention recommendation system provides the set of treatments with associated treatment effectiveness estimates and treatment increments as customer retention recommendations. Table 1 below presents an example of treatment recommendations that can be created based on results of running treatment effectiveness estimator ensembles for the identified treatments for a customer.

TABLE 1
Customer Churn Treatment Recommendations for A Customer

| | | Suggested | |
|---|---|---|---|
| Treatment | Current | Treatment | Estimated Effect on |
| Metrics | Value | (Adjustment) | Churn Likelihood |
| Call Cadence per | 1 | 1 | −14% |
| Month | | | |
| Open Alert Ratio | 31% | −13% | −9% |
| Workload Usage | 82% | 31% | −8% |
| Integration Count | 1 | 1 | −5% |
| Number of Logins | 351 | 25 | −0.019% |
| per Month | | | |

The first column of Table 1 indicates the identifiers of treatments or treatment metrics for which treatment effectiveness ensembles were run. The second column indicates the current value of the treatment of a given row. The third column indicates the suggested adjustment to the treatment of a given row. The fourth column indicates the estimated effect on churn likelihood by the suggested adjustment to the treatment of a given row. According to the first row of the table, increasing call cadence from once per month to twice per month will decrease the likelihood of churn of the customer by an estimated 14%. According to the fourth row of Table 1, increasing the integration count from 1 to 2 will decrease the likelihood of churn of the customer by 5%. Although increasing integration count is the penultimate treatment in terms of estimated effectiveness on customer churn, it may be selected since it requires less resources to implement.

The flowcharts are provided to aid in understanding the illustrations and are not to be used to limit scope of the claims. The flowcharts depict example operations that can vary within the scope of the claims. Additional operations may be performed; fewer operations may be performed; the operations may be performed in parallel; and the operations may be performed in a different order. As mentioned, the operations depicted in blocks 205, 207, 209 can be performed in parallel or concurrently instead of in a loop. Likewise, blocks 305, 307, 309 can be performed in parallel or concurrently instead of in a loop. It will be understood that each block of the flowchart illustrations and/or block diagrams, and combinations of blocks in the flowchart illustrations and/or block diagrams, can be implemented by program code. The program code may be provided to a processor of a general purpose computer, special purpose computer, or other programmable machine or apparatus.

As will be appreciated, aspects of the disclosure may be embodied as a system, method or program code/instructions stored in one or more machine-readable media. Accordingly, aspects may take the form of hardware, software (including firmware, resident software, micro-code, etc.), or a combination of software and hardware aspects that may all generally be referred to herein as a “circuit,” “module” or “system.” The functionality presented as individual modules/units in the example illustrations can be organized differently in accordance with any one of platforms (operating system and/or hardware), application ecosystem, interfaces, programmer preferences, programming language, administrator preferences, etc.

Any combination of one or more machine readable medium(s) may be utilized. The machine readable medium may be a machine readable signal medium or a machine readable storage medium. A machine readable storage medium may be, for example, but not limited to, a system, apparatus, or device, that employs any one of or combination of electronic, magnetic, optical, electromagnetic, infrared, or semiconductor technology to store program code. More specific examples (a non-exhaustive list) of the machine readable storage medium would include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a machine readable storage medium may be any tangible medium that can contain, or store a program for use by or in connection with an instruction execution system, apparatus, or device. A machine readable storage medium is not a machine readable signal medium.

A machine readable signal medium may include a propagated data signal with machine readable program code embodied therein, for example, in baseband or as part of a carrier wave. Such a propagated signal may take any of a variety of forms, including, but not limited to, electro-magnetic, optical, or any suitable combination thereof. A machine readable signal medium may be any machine readable medium that is not a machine readable storage medium and that can communicate, propagate, or transport a program for use by or in connection with an instruction execution system, apparatus, or device.

Program code embodied on a machine readable medium may be transmitted using any appropriate medium, including but not limited to wireless, wireline, optical fiber cable, RF, etc., or any suitable combination of the foregoing.

The program code/instructions may also be stored in a machine readable medium that can direct a machine to function in a particular manner, such that the instructions stored in the machine readable medium produce an article of manufacture including instructions which implement the function/act specified in the flowchart and/or block diagram block or blocks.

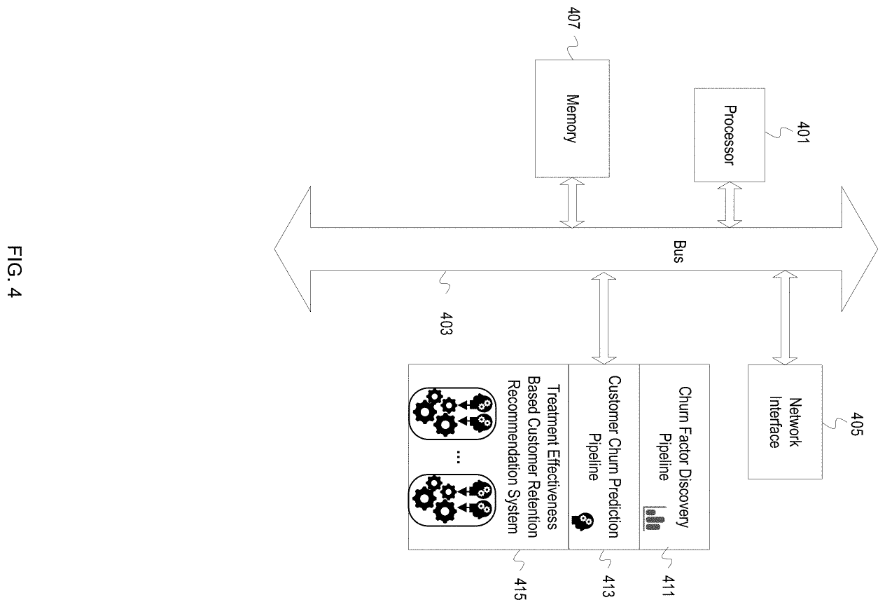

FIG. 4 depicts an example computer system with analytics based customer retention ecosystem. The computer system includes a processor 401 (possibly including multiple processors, multiple cores, multiple nodes, and/or implementing multi-threading, etc.). The computer system includes memory 407. The memory 407 may be system memory or any one or more of the above already described possible realizations of machine-readable media. The computer system also includes a bus 403 and a network interface 405. The computer system also includes a customer retention ecosystem that comprises a churn factor discovery pipeline 411, a customer churn prediction pipeline 413, and a treatment effectiveness based customer retention system 415. The churn factor discovery pipeline 411 statistically analyzes customer data to identify churn factors for use in customer churn prediction. The identified churn factors are those with strong(est) correlations with churn for customers. At least some of the identified churn factors are the basis for features that are input into the customer churn prediction pipeline 413 which runs for multiple customers to generate churn likelihood predictions for the multiple customers. Based on the churn likelihood predictions, the treatment effectiveness based customer retention system 415 creates vectors and inputs the feature vectors into corresponding ones of the treatment specific effectiveness estimator ensembles. Any one of the previously described functionalities may be partially (or entirely) implemented in hardware and/or on the processor 401. For example, the functionality may be implemented with an application specific integrated circuit, in logic implemented in the processor 401, in a co-processor on a peripheral device or card, etc. Further, realizations may include fewer or additional components not illustrated in FIG. 4 (e.g., video cards, audio cards, additional network interfaces, peripheral devices, etc.). The processor 401 and the network interface 405 are coupled to the bus 403. Although illustrated as being coupled to the bus 403, the memory 407 may be coupled to the processor 401.

While the aspects of the disclosure are described with reference to various implementations and exploitations, it will be understood that these aspects are illustrative and that the scope of the claims is not limited to them. In general, techniques for customer churn prediction and estimating churn treatment effectiveness as described herein may be implemented with facilities consistent with any hardware system or hardware systems. Many variations, modifications, additions, and improvements are possible.

Use of the phrase “at least one of” preceding a list with the conjunction “and” should not be treated as an exclusive list and should not be construed as a list of categories with one item from each category, unless specifically stated otherwise. A clause that recites “at least one of A, B, and C” can be infringed with only one of the listed items, multiple of the listed items, and one or more of the items in the list and another item not listed.

1. A method comprising:
obtaining control variables for a first customer, wherein the control variables comprise observable attributes of the first customer and potential covariates with both customer churn outcome and customer churn treatment selection;
determining current state of each of a plurality of customer churn treatments;
for each of the plurality of customer churn treatments,
forming a feature vector with the control variables and the current state of the customer churn treatment;
running a causal inference model on the feature vector to obtain a treatment effectiveness estimate for the treatment based on the feature vector; and
indicating the treatment effectiveness estimate with an identifier of the treatment; and
providing the plurality of treatment identifiers with treatment effectiveness estimates.

2. The method of claim 1, wherein the causal inference model comprises an ensemble of models including a causal forest and double estimators previously trained with historical observations of customer churn treatment selections and outcomes across multiple customers, wherein a first of the double estimators was trained to fit churn outcomes to the control variables and a second of the double estimators was trained to fit treatment selection to the control variables.

3. The method of claim 1 further comprising training the causal inference model with data corresponding to the control variables from across multiple customers.

4. The method of claim 1 further comprising indicating, for each of the plurality of customer churn treatments, treatment rate with the treatment effectiveness and the treatment identifier.

5. The method of claim 3 further comprising scaling at least a first of the treatment rates for a first of the plurality of customer churn treatments with respect to a second of the treatment rates for a second of the plurality of customer churn treatments.

6. The method of claim 1 further comprising:
refreshing customer churn features to be input into a customer churn prediction model based on detection of a refresh trigger;
for each of a plurality of customers which includes the first customer,
forming a churn prediction feature vector with the refreshed customer churn features;
running the customer churn prediction model on the customer churn prediction feature vector; and
indicating a churn likelihood prediction for the customer; and
selecting the first customer based, at least in part, on the churn likelihood predictions.

7. The method of claim 5 further comprising selecting a subset of a plurality of customer variables as the customer churn features based on correlation coefficients determined from cross-customer statistical analysis of customer data for customers with churn outcomes.

8. The method of claim 7 further comprising determining the correlation coefficients with Spearman rank order analysis.

9. The method of claim 7, wherein the correlation coefficients indicate strength and direction of correlations between churn outcomes and the control variables.

10. The method of claim 6, wherein the refresh trigger comprises expiration of a time interval or accumulation of a threshold amount of additional customer data.

11. A non-transitory, computer-readable medium having program code stored thereon, the program code comprising program code to:
indicate a plurality of customer churn treatments and select a causal inference model previously trained for each of the customer churn treatments;
obtain control variables for a first customer, wherein the control variables comprise observable attributes of the first customer and potential covariates with both customer churn outcome and customer churn treatment selection;
determine current state of each of the plurality of customer churn treatments for the customer;
for each of the causal inference models,
form a feature vector with the control variables and the current state of the customer churn treatment corresponding to the causal inference model;
run the causal inference model on the feature vector to obtain a treatment effectiveness estimate for the customer churn treatment based on the feature vector; and
indicate the treatment effectiveness estimate with an identifier of the customer churn treatment; and
provide the plurality of treatment identifiers with treatment effectiveness estimates.

12. The non-transitory, computer-readable medium of claim 11, wherein each causal inference model comprises an ensemble of models including a causal forest and double estimators, wherein a first of the double estimators was trained to fit churn outcomes to historical control variables and a second of the double estimators was trained to fit treatment selection to the historical control variables.

13. The non-transitory, computer-readable medium of claim 11 further comprising program code to train the causal inference model with data corresponding to the control variables from across multiple customers.

14. The non-transitory, computer-readable medium of claim 11 further comprising program code to indicate, for each of the plurality of customer churn treatments, treatment rate with the treatment effectiveness and the treatment identifier.

15. The non-transitory, computer-readable medium of claim 14 further comprising program code to scale at least a first of the treatment rates for a first of the plurality of customer churn treatments with respect to a second of the treatment rates for a second of the plurality of customer churn treatments.

16. The non-transitory, computer-readable medium of claim 11 further comprising program code to:
refresh customer churn features to be input into a customer churn prediction model based on detection of a refresh trigger;
for each of a plurality of customers which includes the first customer,
form a churn prediction feature vector with the refreshed customer churn features;
run the customer churn prediction model on the customer churn prediction feature vector; and
indicate a churn likelihood prediction for the customer; and
select the first customer based, at least in part, on the churn likelihood predictions.

17. The non-transitory, computer-readable medium of claim 16 further comprising program code to select a subset of a plurality of customer variables as the customer churn features based on correlation coefficients determined from cross-customer statistical analysis of customer data for customers with churn outcomes.

18. An apparatus comprising:
a processor; and
a computer-readable medium having program code stored thereon that are executable by the processor to cause the apparatus to,
for each of a plurality of treatment effectiveness estimators each of which has been trained for a different customer churn treatment,
form a feature vector with control variables and a current state of a customer churn treatment corresponding to the treatment effectiveness estimator, wherein the control variables comprise observable attributes of a customer and potential covariates with both customer churn outcome and customer churn treatment selection;
run the treatment effectiveness estimator on the feature vector to obtain a treatment effectiveness estimate for the customer churn treatment based on the feature vector; and
indicate the treatment effectiveness estimate with an identifier of the customer churn treatment; and
provide the plurality of treatment identifiers with treatment effectiveness estimates.

19. The apparatus of claim 18, wherein each treatment effectiveness estimator comprises an ensemble of models including a causal forest and double estimators, wherein a first of the double estimators was trained to fit churn outcomes to historical control variables and a second of the double estimators was trained to fit treatment selection to the historical control variables.

20. The apparatus of claim 18, wherein the program code further comprises program code to:
refresh customer churn features to be input into a customer churn prediction model based on detection of a refresh trigger;
for each of a plurality of customers,
form a churn prediction feature vector with the refreshed customer churn features;
run the customer churn prediction model on the customer churn prediction feature vector; and
indicate a churn likelihood prediction for the customer; and
select from the plurality of customers based, at least in part, on the churn likelihood predictions for customer churn treatment recommendations.
